(19) United States
(12) Patent Application Publication
(10) Pub. No.: US 2009/0306816 A1
(43) Pub. Date: Dec. 10, 2009

(54) Sequential Selective Sorting Method and Installation for Implementing it

(75) Inventors: Martin Champel, Neuville-sur-Saone (FR); Olivier Doyen, Nanterre (FR); Christophe Gambier, Asnieres (FR); Ella Labonne, Courdimanche (FR)

Correspondence Address: HARNESS, DICKEY & PIERCE, P.L.C., P.O. BOX 828, BLOOMFIELD HILLS, MI, 48303, US

(73) Assignee: VEOLIA PROPRETE, Nanterre (FR)

(21) Appl. No.: 12/440,620

(22) PCT Filed: Jul. 26, 2007
(86) PCT No.: PCT/FR07/01295

§ 371 Date: Apr. 20, 2009

(30) Foreign Application Priority Data
Sep. 11, 2006 (FR) 0607931

(51) Int. Cl. B07C 5/34

(52) U.S. Cl. 700/223

(57) ABSTRACT

The present invention relates in general to a method for selectively sorting miscellaneous items, particularly waste, which allows various types of items to be sorted sequentially, and to a selective sorting installation suited to such a method.

### FIELD

The present invention generally relates to a selective sorting process for various objects, allowing the sequential sorting of different types of objects, and to a selective sorting installation adapted to said process.

In particular, the present invention concerns a selective sorting process and installation which find more particular application in the area of waste sorting.

### BACKGROUND

On the whole, the general sorting process of waste is broken down into several successive steps, to allow the gradual fining of the separation between the different components of a flow of waste to be sorted. It generally comprises the following successive steps:
a) manual extraction of large objects and/or rough crushing,
b) extraction of fine elements by screening for example,
c) morphological separation, possibly followed by a step to redirect mis-sorted waste, and
d) separation per material.

The invention more particularly concerns the sorting step d) to separate material.

As is known, this step of the general process of waste sorting is ensured by automatic sorting machines operating along the principle of detection of the presence of an object followed by recognition of the material, associated with pneumatic ejection, such as the machines illustrated FIGS. 1 and 2. These automatic sorting machines 1 to sort waste 2 are frequently used in waste sorting centers. Particular mention may be made of the sorting machines marketed by BINDER & Co, MSS (MAGNETIC SEPARATION SYSTEMS), NATIONAL RECOVERY TECHNOLOGIES, PELLENC SELECTIVE TECHNOLOGIES, RTT SYSTEMTECHNIK GmbH and TITECH VISIONSORT. The sorting machine shown FIG. 1 comprises:
a fast conveyor belt 3 to move the waste 2 in a stream 21 towards a sorting station 5 comprising:
   a material-recognition device 51 to detect and locate each waste item 2 of the stream 21, to analyze and identify its constituent material, then to assign a waste type to it identified from among a group of predefined types, or to consider it as undesirable,
   a calculator 52 (not shown FIG. 1) which defines an order of ejection or non-ejection in relation to the results of the analysis performed by the material-recognition device 51, and in relation to a sorting instruction added manually, and
   an array 53 of ejection nozzles positioned below the plane of the conveyor belt 3 and whose nozzles, which are supplied with compressed air by solenoid valves controlled by the calculator 52, are able to give the waste items 2 to be ejected a range of movement allowing lengthening of their trajectory when ejected from the belt, so that the ejected waste 22 can reach:
the receiver device 6 which generally consists of a conveyor belt (as is the case for the sorting machine in FIG. 1) or various containers (as is the case for the sorting machine in FIG. 2).

This sorting machine also comprises an evacuation device 7 which receives the non-ejected objects which are then conveyed towards another sorting machine 1.

It is to be noted that this sorting machine can eject objects belonging to one of the desired classes, in which case the term positive sorting is used, as well as all undesirables in which case the term negative sorting is used.

According to one more complex embodiment of the sorting machine 1, such as the one shown FIG. 2 for example, the machine can be equipped with a second ejection array 54 placed above the plane of the conveyor belt 3 and whose jets are directed downwards. Its nozzles are able to give pulses directed from top to bottom and hence to shorten the trajectory of the objects ejected from the belt. This therefore allows two different types of products to be sorted in one single pass.

However, it is not possible, with said sorting machines, to sort a higher number of types of objects since these machines, through their construction, are limited to the simultaneous sorting of no more than two types of objects or groups of object types. To sort a greater number of products, e.g. six or more, several machines must be combined together.

Another disadvantage with this type of machine is related to the heterogeneity and variability of the composition of the entering flows of waste to be sorted.

This translates as very large fluctuations in the instant flow rate within the different machines, these fluctuations being greater the more the machines operate at the downstream end of the sorting process, which is more particularly the case for machines dedicated to separating into categories of materials. These fluctuations in flow rate are likely at times to cause sub-feeding to the sorting machine, and at other times to cause saturation by exceeding machine capacity. To avoid this latter situation which translates as deteriorated quality of sorting, the solution generally applied consists of oversizing these machines, which increases the risk of sub-feed and is very detrimental to operating economy.

### SUMMARY

The purpose of the present invention is therefore to propose a selective sorting process and a sorting installation adapted to implement this process, allowing technical performance levels to be improved in particular in terms of flow rate and the number of objects of different types which can be sorted simultaneously, and which overcome the disadvantages of the prior art.

For this purpose, the present invention proposes a selective sorting process adapted to the sorting of waste consisting of objects of several mixed types and belonging to different predefined classes of objects it is desired to separate from each other, or to a particular class of undesirables, this process comprising:
a conveying operation, consisting of moving these objects in the form of a stream between an input and an output,
a material recognition operation, consisting of analyzing and identifying each object of the moving stream and of associating it either with a type of object identified from among a group of predefined types or with an undesirable type, and
a separating operation per material, consisting of directing the objects of different types, on leaving the conveyor stream, towards different containers.

Throughout the separating step into materials d) not only are the desired different classes or types of objects separated from each other, but also the different undesirables are extracted therefrom.

By undesirable, in the meaning of the present invention, is meant any object present in the waste flow which does not belong to any of the desired predefined object types.

For n classes of desired objects, sorting must be made into n+1 classes, the class over and above this number corresponding to undesirables.

According to the process of the present invention, the separating operation is implemented by sequentially eliminating from the stream those objects of the different types which are chosen in turn from the group of predefined types of objects, and from the particular class of undesirables, and in that it further comprises a recycling operation consisting of sending back to the input at least part of the stream of objects which has reached the output.

With the process of the invention it is possible, by organizing the sorting sequentially, to sort in succession a broad spectrum of different objects. This sequential organization of sorting is made possible by re-adding non-ejected objects to the upstream portion.

The present invention also concerns a sorting installation adapted for the implementation of the sorting process according to the invention, which comprises:
a) packing and conveying means able to move these objects in the form of a stream between an input and an output,
b) analysis means installed on the pathway of the stream of objects and able to analyze and identify each object in the moving stream and to assign an object type to it, identified either from among a group of predefined types or identified as an undesirable, and
c) separating means installed at the output, controlled at least by the analysis means and able to evacuate the identified objects by sending them towards different respective containers.

According to the present invention, the sorting installation further comprises:
d) recycling means which are able to send back objects to the input from the stream of objects which have reached the output without being evacuated, and
e) piloting means which are able to control the separating means so as to evacuate objects of different types from the stream, chosen sequentially in relation to the types of objects identified by the analysis means.

The sorting installation of the present invention allows near-permanent utilization of the sorting machine at its nominal flow rate, which extends its scope of use, in particular to very complex or very heterogeneous flows, or even to both at the same time, and also to materials present in small proportion or to low deposits.

### DRAWINGS

Other advantages and particular aspects of the present invention will become apparent in the embodiments given as non-limiting examples illustrated by the appended drawings in which:

FIG. 1 is a schematic view of a first embodiment of a prior art waste sorting installation,

FIG. 2 is a schematic view of a second embodiment of a prior art waste sorting installation,

FIG. 3 is a schematic view of a first embodiment of a sorting installation according to the present invention,

FIG. 4 is a schematic view of a second embodiment of a sorting installation according to the present invention,

FIG. 5 is a schematic view of a third embodiment of a sorting installation according to the present invention,

FIG. 6 is a schematic view of a fourth embodiment of a sorting installation according to the present invention,

FIG. 7 is a partial schematic view of the device to receive ejected objects, illustrating in detail a first embodiment of the guiding device for these objects,

FIG. 8 is a partial schematic view of the device to receive ejected objects 22, illustrating in detail a second embodiment of the guiding device for these objects,

FIG. 9 is a partial schematic view of the device to receive ejected objects, illustrating in detail a third embodiment of the guiding device for these objects, and

FIG. 10 is a partial schematic view of the device to receive ejected objects, illustrating in detail a fourth embodiment of the guiding device for these objects.

### DETAILED DESCRIPTION

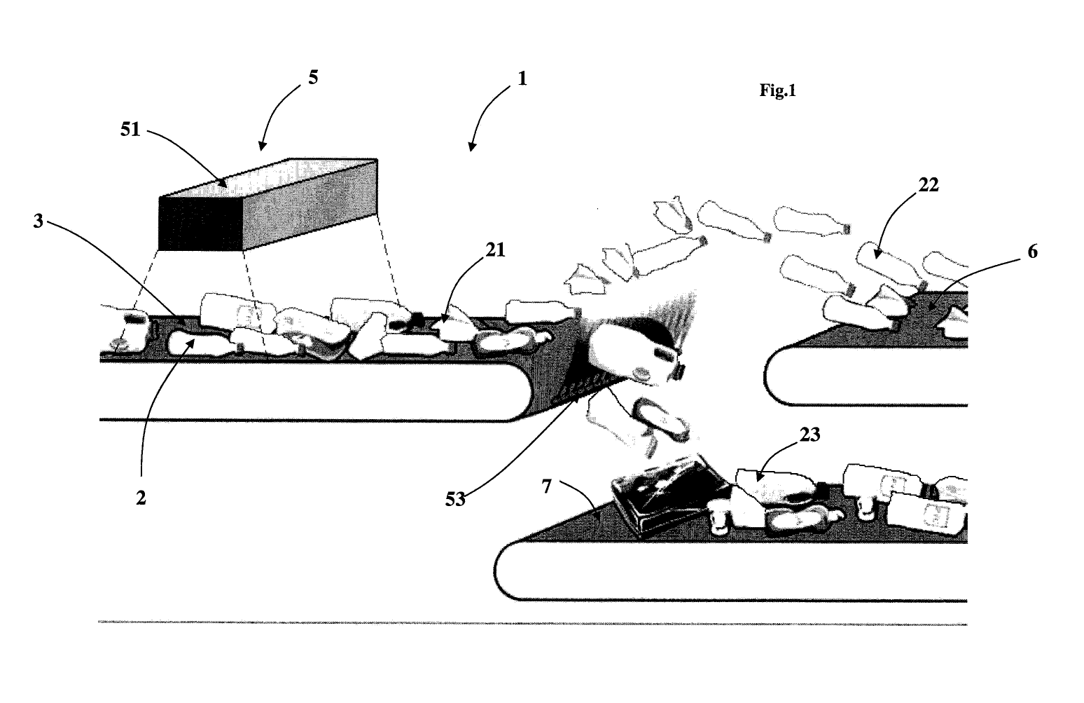

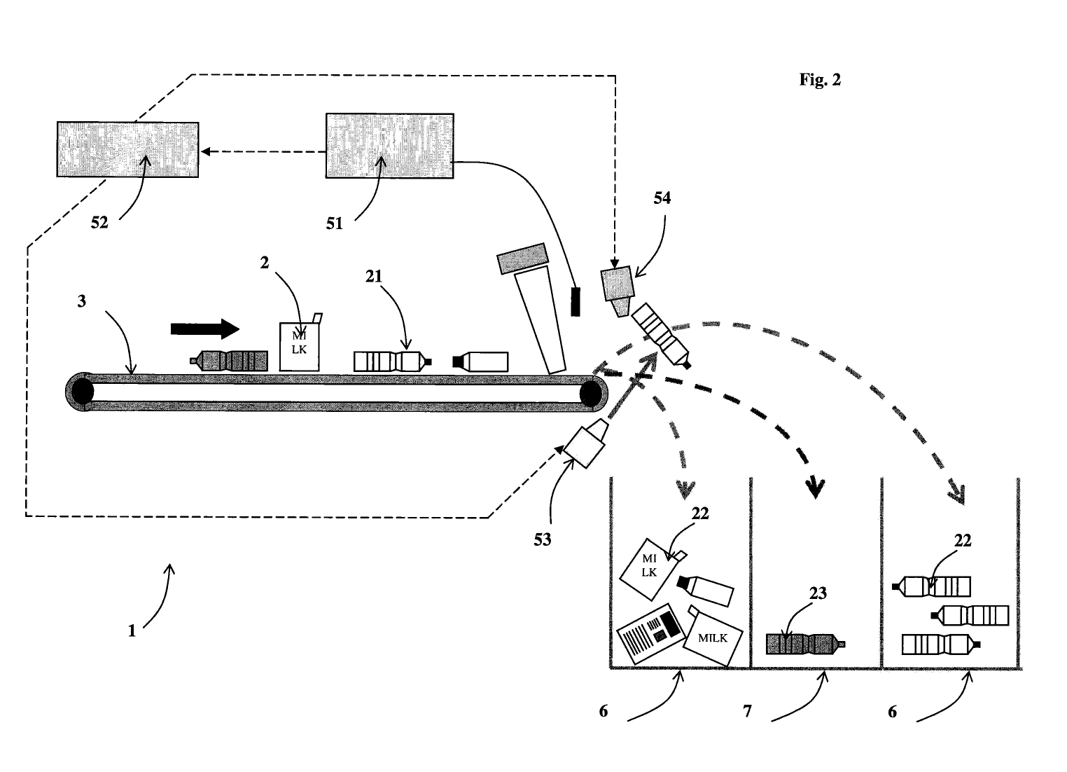

The prior art sorting installations shown FIGS. 1 and 2 were described above with reference to the prior art.

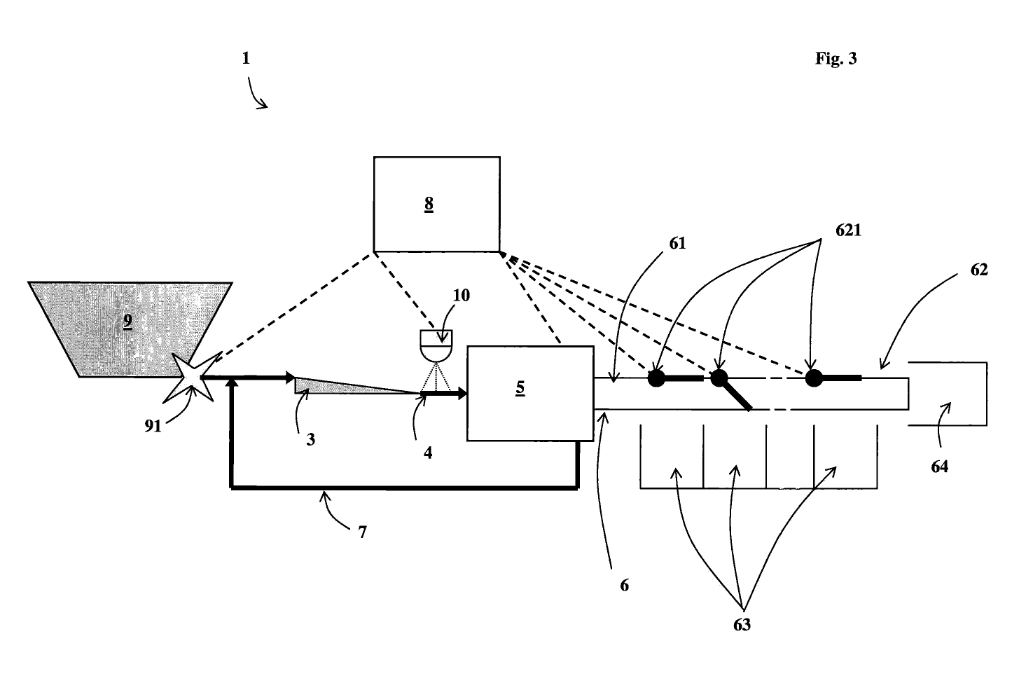

With reference now to FIG. 3, a sorting installation 1 according to a first embodiment of the present invention comprises:
a spreader device 3, consisting of a vibration supply 3 for example, to arrange the objects 2 into a substantially single-layer stream as they enter the sorting device 1,
a feed conveyor 4 to convey said objects 2 towards:
   at least one automatic sorting station 5 which recognizes and sorts the objects 2 in the stream, which is preferably a single-layer stream, and divides them into objects to be ejected 22 and objects not to be ejected 23,
   a device 6 to receive the ejected objects 22 which comprises:
      a conveying device 61 to convey the ejected objects 22 derived from the sorting station 5 towards
      a guiding device 62 to guide the ejected objects 22, comprising a plurality of deflectors 621 as many in number as the number of types of different products, to distribute the ejected objects 22, in relation to the sorting instruction, towards
      a plurality of containers 63 able to receive the ejected objects 22 belonging to either one of the desired predefined types, these containers being identical in number to the number of products of desired different types,
      a container 64 able to receive ejected objects 22 belonging to the particular class of undesirables,
a recirculation loop 7 to send the non-ejected objects 23 from the sorting device 1 back to upstream of the spreader device 3,
a central control module 8.

FIG. 3 also shows the presence of:
a buffer storage device 9 arranged upstream of the spreader device 3 to uncouple the sorting machine 5 from the remainder of the sorting installation 1,
a flow-rate adjustment device 91 to adjust the flow-rate of the objects 2 leaving the storage device 9, to maintain constant the feed flow-rate of objects 2 to the sorting machine 5 by compensating for fluctuations in the flow of recycled objects 23 by fluctuations of same amplitude but of opposite sign to that of the flow of objects 2 derived from the buffer storage device 9,
a probe 10 to measure flow-rate, placed upstream of the sorting machine 5 at the feed conveyor 4 to determine the feed flow-rate of objects 2 to the sorting machine 5.

The sorting station 5 of the sorting installation 1 according to the invention is similar to the one generally used in prior art sorting installations 1, such as the one illustrated FIG. 1 for example which comprises:
a material recognition device 51,
a calculator 52, and
an array 53 of ejection nozzles located either below the feed conveyor 4, with jets directed upwardly capable of giving pulses allowing lengthening of the trajectory of the objects to be ejected 22, or above the feed conveyor 4 with jets directed downwardly capable of giving pulses allowing shortening of the trajectory of the objects to be ejected 22.

The material-recognition devices of these sorting stations 5 chiefly use analysis of the spectrum reflected by the objects to be sorted, in the near-infrared range (wavelengths of 700 to 1500 nm) using an optical sensor which indicates the location on the conveyor belt of the object to be sorted and gives a specific signature of its constituent molecule. This is the case in particular for the different plastic resins (polyethylene terephtalate or PET, low density polyethylene or LDPE, high density polyethylene or HDPE, polypropylene or PP, polyvinyl chloride or PVC, polyacrylonitryle or PAN, polystyrene or PS, polycarbonate or PC, polyamide or PA, polymethyl methacrylate or PMMA.) and for products of paper or cardboard type containing cellulose fibers. This type of detection is also able to recognize certain special associations of materials, as is particularly the case with liquid food packaging (LFP), whose outer layer consisting of cardboard coated with HDPE gives a specific signature.

Finer separations can be obtained by coupling the recognition of the materials desired above with other types of detections such as the color of the objects or the general tone and number of colors used for printing. This last type of analysis is conventionally used to differentiate between print or writing papers from those intended to manufacture wrappings.

Spectral analysis does not give good performance for metal detection, in particular non-ferrous metals. When such detection is necessary, the sorting machines are also provided with induction or Foucault current sensors. Disturbance of the electromagnetic field caused by the passing of a metal object in front of the sensor is identified, located and converted into an instruction to eject the corresponding object.

The central control module 8 is able:
to define and/or modify the sorting instruction for the calculator 52 of the sorting machine 5,
to configure the guiding device 62 in relation to the sorting instruction, and
to adapt the sorting instruction to make it optimal in relation to statistical processing of the results of the analyses made by the analysis device 51.

As probes 10 to measure flow rate, which can be used in the sorting installation 1 of the present invention, particular mention can be made of ultrasound probes which allow measurement of the height of the waste stream 21 on the feed conveyor 4, or optical sensors which can measure the occupancy rate of objects 2 on the feed conveyor 4.

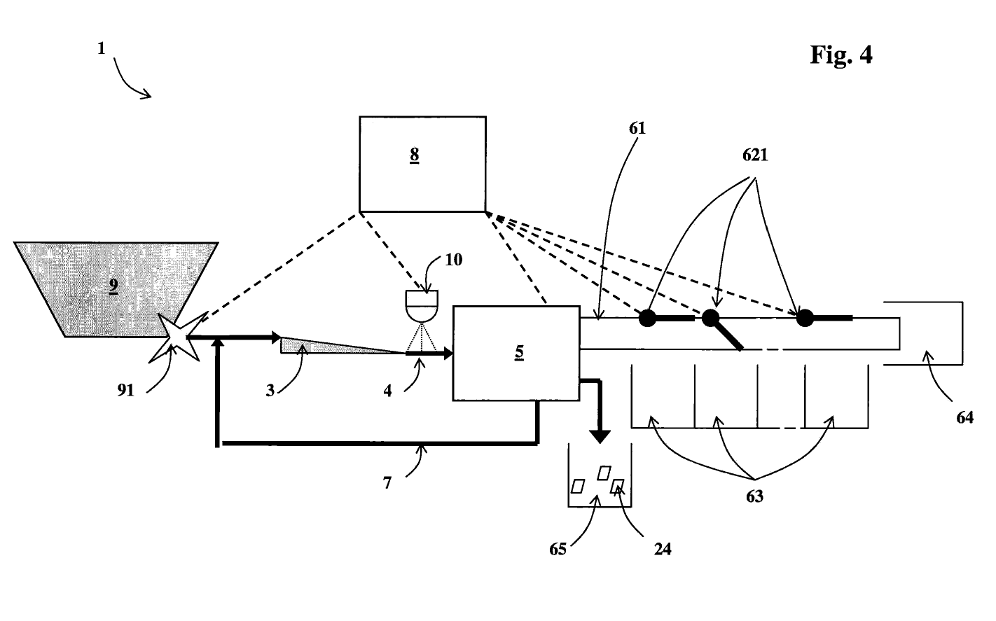

A sorting installation 1 according to a second embodiment of the present invention is shown FIG. 4. This sorting installation 1 is adapted in particular to the case in which one of the predefined types of objects 2 to be extracted is largely in majority compared with all the others, which warrants continuous extraction of this majority product. The sequential organization of sorting therefore only concerns the objects 2 belonging to the other predefined types, and to undesirables. In this embodiment, the automatic sorting station 5 is of dual-ejection type, top and bottom, such as the one shown FIG. 2. One of the outputs, for example the one corresponding to upward ejections, is assigned to the continuous ejection of the majority product 24 collected in the container 65. The other output, corresponding to downward ejection, serves the conveying device 61, the guide device 62 and the plurality of containers 63, 64 as indicated above in the comments on FIG. 3.

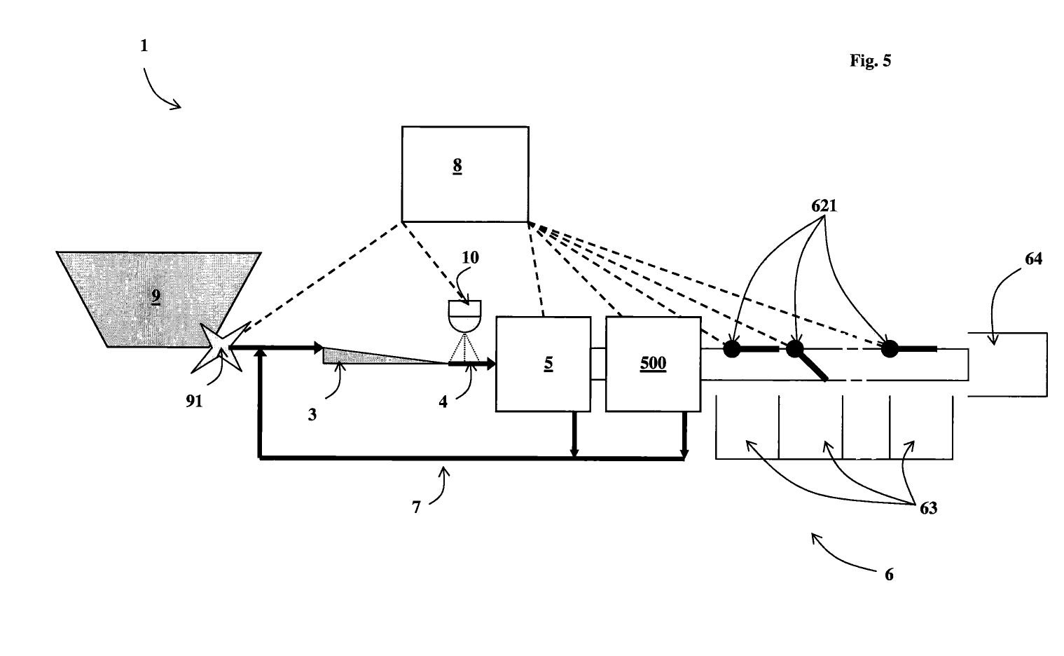

FIG. 5 shows a sorting installation 1 according to a third embodiment of the present invention, which comprises two sorting stations 5, 500 which are arranged in series upstream of the device 6 to receive the ejected objects 22 and are piloted by the central control module 8 which, in parallel and simultaneously, ensures switching of instructions between the two sorting machines 5, 500.

When purity requirements for each of the sorting stations 5 cannot be guaranteed in one single sorting step, it is necessary to use two sorting stations 5, 500; the first sorting station 5 is intended to sort 5 objects 2, and the second sorting station 500 is used to control the quality of sorting performed by the first sorting machine 5 i.e. by ejecting sorting errors from the flow of objects 2 sorted by the first sorting station 5. The sorting performed at sorting station 5 is therefore positive, and the sorting performed at sorting station 500 is negative sorting.

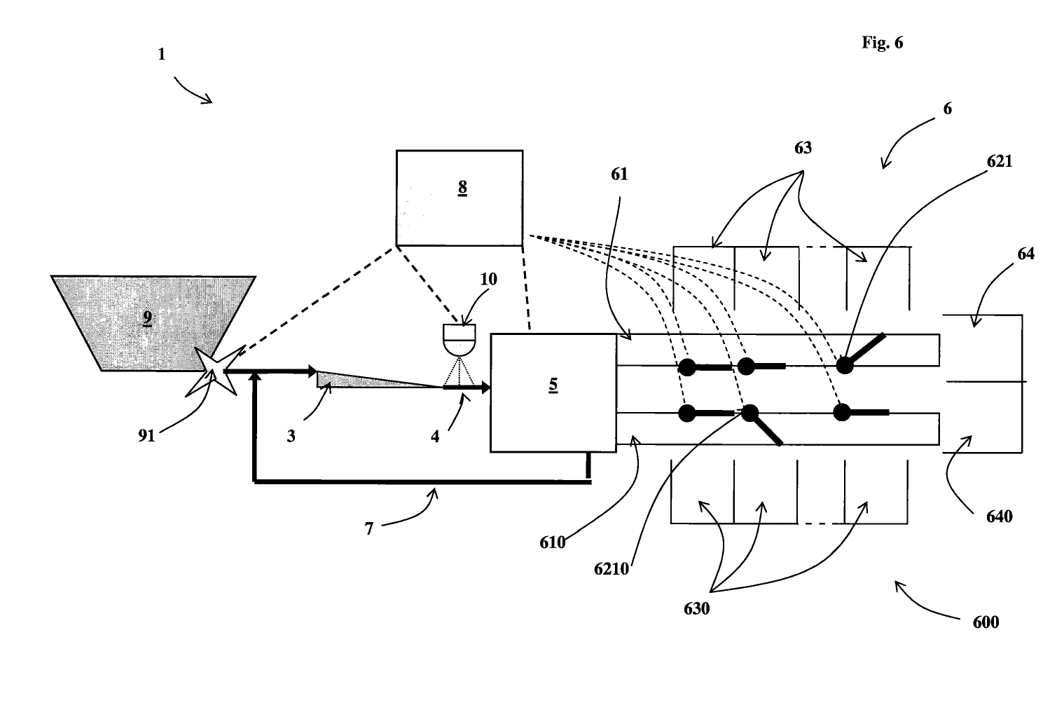

FIG. 6 shows a sorting installation 1 according to a fourth embodiment of the present invention, comprising two ejection devices (not shown FIG. 6) located in the sorting station 5 (for example two arrays of ejection nozzles) and two devices 6, 600 receiving the ejected objects 22 which are each coupled to one of the ejection devices.

Each device 6 to receive the ejected objects 22 comprises:
an object conveying device 61,610, each cooperating with one of the ejection devices of the sorting station 5;
a feed device 62,620 feeding ejected objects; and
two series of deflectors 621,6210; and
two series of containers 63,630 for the desired predefined types of objects; and
two containers 64,640 for undesirables.

The guide devices 62,620 mentioned above may have different forms depending on the geometry of the installation and in particular of the conveying device 61,610. By way of indication, mention may be made in particular of devices 6,600 to receive the ejected objects 22 in which the conveying device 61,610 for the 10 ejected objects is configured so as to ensure substantially horizontal conveying of the ejected objects 22 towards the guide device 62, and the deflectors 621 of the guide device 62 are configured to push the ejected objects 21 so that they leave the conveying device 61 when they are above the container 63,630 assigned to them by the sorting instruction, or are configured so as to allow the ejected objects 21 to continue being conveyed without deflection as far as container 64,640 if such objects are undesirables.

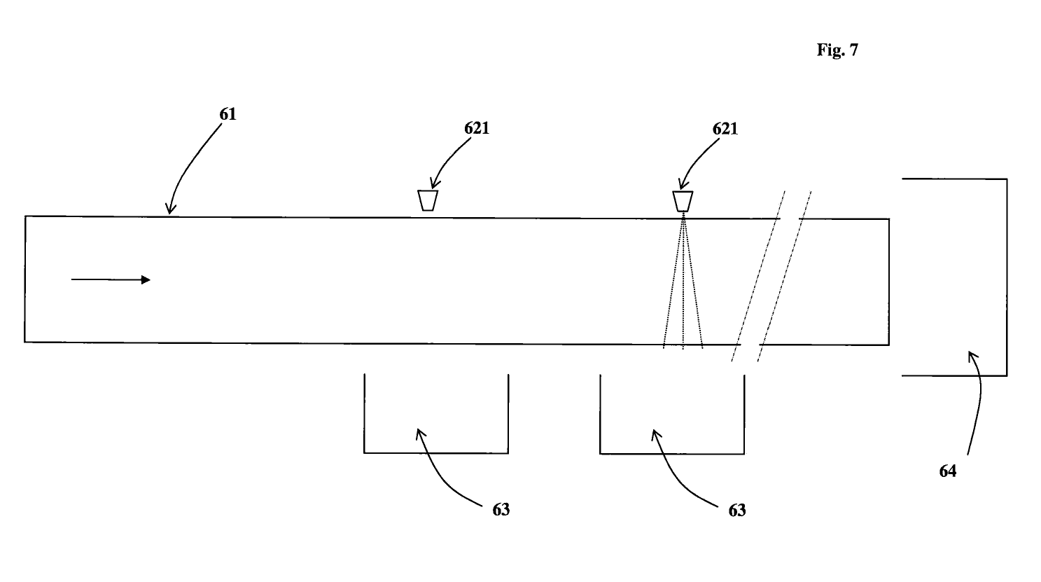

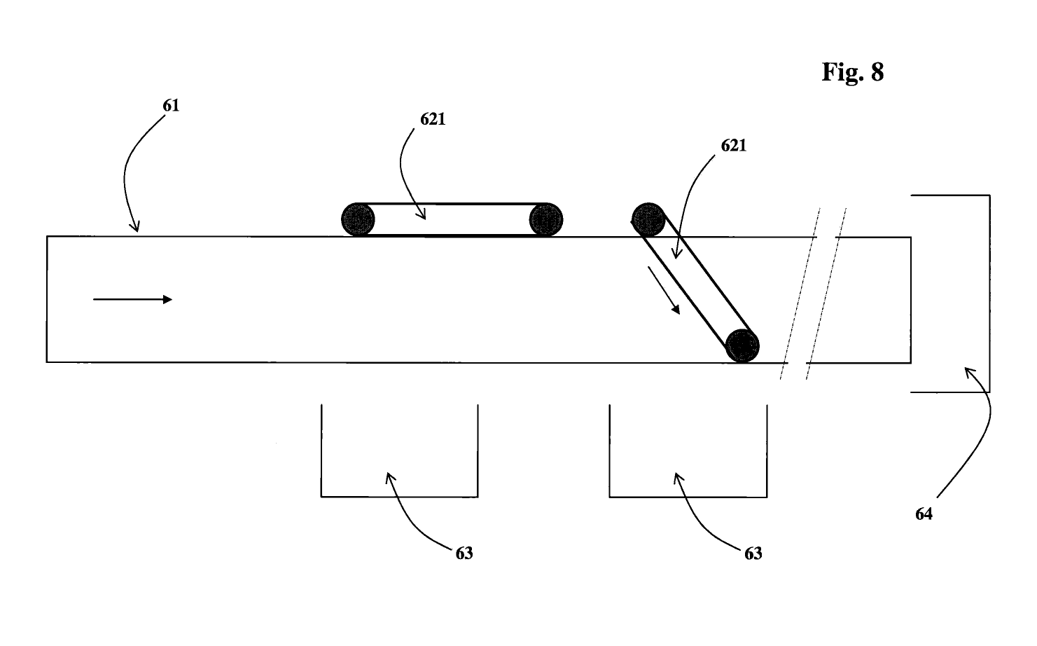

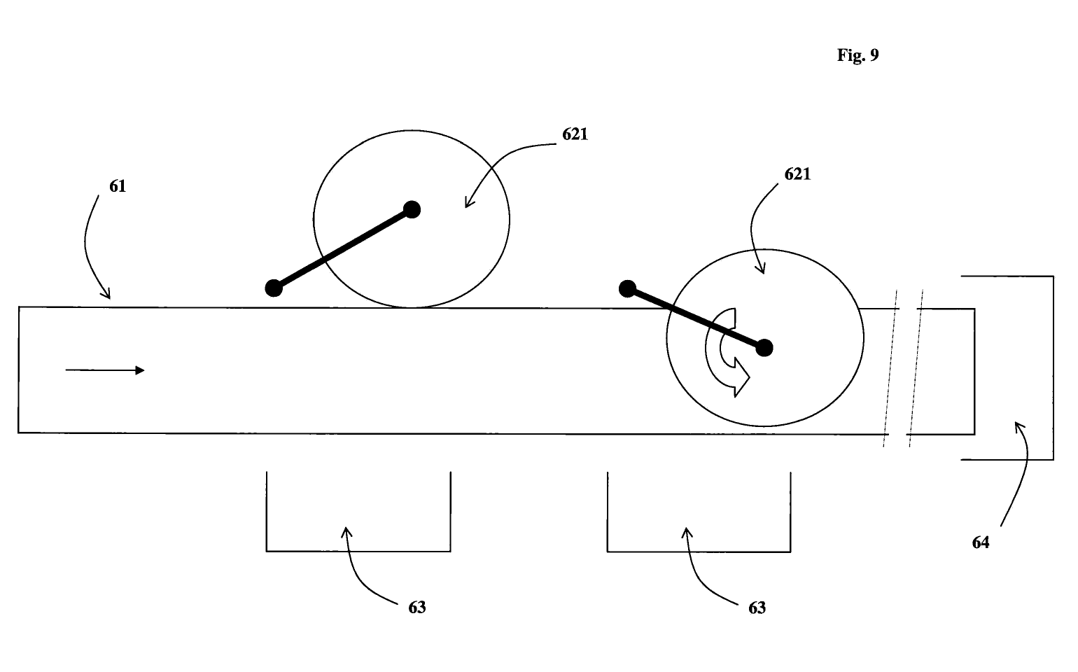

For example, as conveying device 61, a conveyor belt can be used and the deflectors 621 may be:
air jet deflectors as shown FIG. 7, or
belt deflectors as shown FIG. 8, or
drum deflectors as shown FIG. 9.

As guide device 62, 620, which can be used in the sorting installation of the present invention, mention may also be made of devices 6,600 to receive the ejected objects 22 in which the conveying device 61,610 is configured to ensure substantially vertical conveying of the objects 21 ejected towards the guide device 62,620, and the deflectors 621, 6210 of the guide device 62,620 are configured to guide the ejected objects 21 downwardly just above their assigned container 63,630 or 64,640.

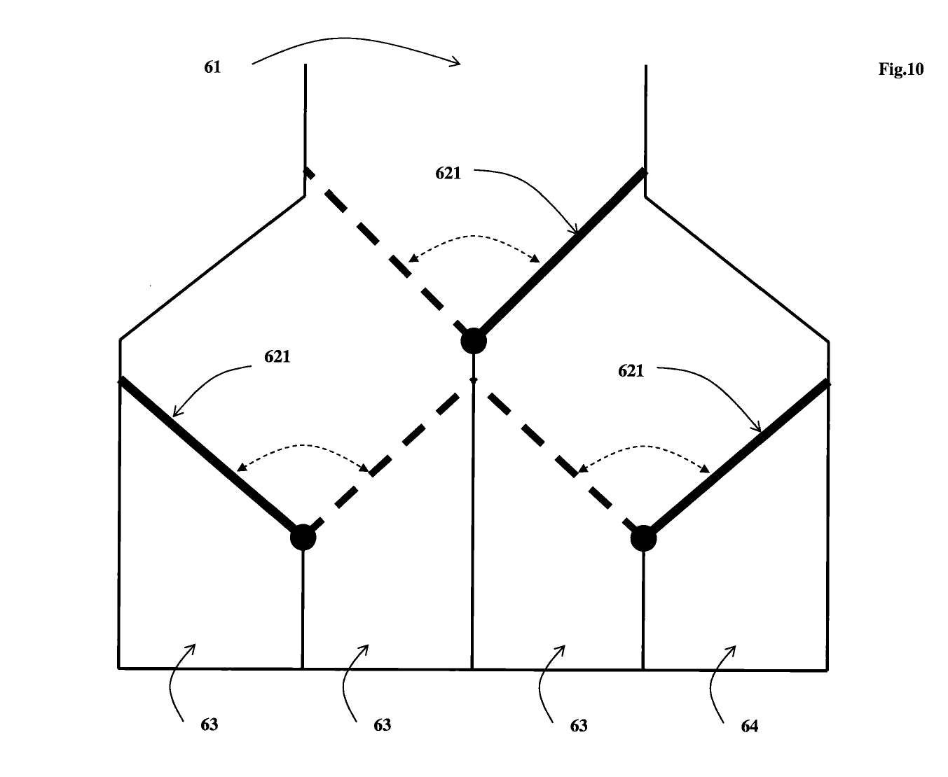

It is possible as conveyor device 61,610 to use a hopper for example, and deflectors 621, 6210 consisting of a set of flaps arranged in the hopper able to pivot about a horizontal axis so as to delimit a conveying duct for the objects 22 towards their assigned container 63,630 or 64, 640, as is shown FIG. 10.

To describe the functioning of the invention, the different types of predefined objects to be extracted are denoted A to M. The specific class of undesirables is denoted N.

The sequential sorting of objects 2 using the sorting installation of the invention such as illustrated FIG. 3 is conducted as follows:

1) definition of an initial sorting instruction by the central control module 8, resulting from one of the following options: instruction predefined by the user, or defined by the control module 8 either randomly or in relation to historical knowledge of the composition of the flow to be sorted acquired during previous uses of the device; this initial sorting instruction indicates that the initial sorting sequence consists for example of separating the objects 2 of type A from the other objects of type B, C, . . . N;

2) transmission of the initial sorting instruction to the calculator 52 which defines the following order of sorting:
ejection of objects 2 of type A and their conveying towards the guide device 62,
re-adding of the other objects 2 of type B,C . . . or N into the recirculation loop 7,

3) configuration by the central control module 8 of the guide device 62 to extract the objects of type A and to guide them towards their assigned container 63;

4) start of the sorting sequence of objects of type A;

5) throughout the sorting sequence, the contents of objects 2 of type B,C, . . . or N gradually increase until the content of one of the objects of type B,C . . . N reaches one of the threshold values S_{B}, S_{C}, . . . or S_{N}; let S_{B} for example be the first threshold reached;

6) interruption of the sorting sequence of the objects of type A, to give way to the following sorting sequence i.e. that of objects of type B;

7) modification, by the central control module 8, of the initial sorting instruction which is replaced by the sorting instruction concerning the sorting sequence of objects 2 of type B, consisting of separating the objects 2 of type B from the other objects of type A, C, . . . or N;

8) transmission of the sorting instruction for objects 2 of type B to the calculator 52 which defines the following order of sorting:
ejection of the objects 2 of type B for their conveying towards the guide device 62;
re-adding of the other objects 2 of type A, C, . . . or N into the recirculation loop 7;

9) configuration by the central control module 8 of the guide device 62 to extract objects 2 of type B and to guide them towards their assigned container 63;

10) resuming of sorting by the sorting sequence of objects 2 of type B;

11) throughout the sorting sequence, the contents of objects 2 of type A, C, . . . or N increase progressively until the content of one of the objects of type A C, or N reaches one of the threshold values S_{A}, S_{C}, . . . or S_{N};

12) as soon as one of these thresholds is exceeded, the sorting sequence of the objects 2 of type B is interrupted;

13) continuation of the sorting process using the sorting sequence for objects of the following type which caused overstepping of a threshold, by reproducing steps similar to steps 5 to 12 described above, and;

14) and so on for the different objects 2 to be sorted.

When the objects 2 to be sorted are undesirables N, the process is globally the same, with the exception that the configuration of the guide device 62 must then be directed towards container 64.

This sequential organization of sorting, according to the process of the invention, allows real-time self-adaptation of the sorting sequences in relation to the characteristics of the composition of the flow of entering objects and of the flow of recycled objects, these compositions being expressed as contents of objects of the different types, predefined and undesirables, within these flows.

Therefore, with the exception of the short stops needed for switching of the sorting instructions, the sorting station 5 permanently operates at its nominal capacity, which increases its productivity compared with prior art functioning.

It is also possible to predefine the sequencing of the sorting sequences, and to repeat this linear sequencing in unchanging manner:

ABCD . . . NABCD . . . N . . .

This operating mode, less optimized than the one described previously, can however prove to be necessary for adjustments in particular. It can also form a failsoft mode maintaining the capability to sort several types of objects 2 using a single automatic sorting station 5.

1. A selective sorting process, adapted to the sorting of waste flow objects of several mixed types, the process comprising:
a conveying operation consisting of moving said objects in the form of a stream between an input and an output;
a material recognition operation consisting of analyzing and identifying each object in the moving stream and associating it either with a type of object identified from among a group of predefined types or with an undesirable type; and
a separating operation per material consisting of directing the objects belonging to either one of the different types, when they leave the stream, towards different containers;
wherein the separating operation is conducted by sequentially eliminating from the stream those objects of different types which are chosen in turn from the group of predefined types of objects and from undesirables; and
wherein the sorting process further comprises a recycling operation for sending back towards the input at least part of the stream of objects which has reached the output.

2. The process according to claim 1, wherein the objects which are identified as undesirable are directed, on leaving the stream, towards an additional container different from the containers intended to receive objects belonging to either one of the predefined types.

3. An installation for selective sorting, adapted to the sorting of waste objects of several mixed types, the installation comprising:
a) packing and conveying means able to move said objects in the form of a stream between an input and an output;
b) analysis means installed on the pathway of the stream of objects and able to analyze and identify each object of the moving stream and to assign an identified object type thereto from among a group of predefined types; and
c) separating means installed at the output controlled at least by the analysis means and capable of evacuating the identified objects by sending them towards respective different containers, further comprising:
d) recycling means capable of sending back towards the input those objects in the stream of objects which have reached the output without being evacuated; and
e) at least one piloting means capable of controlling the separating means so as to evacuate from the stream those objects of different types chosen sequentially in relation to the types of objects identified by the analysis means.

4. The sorting installation according to claim 3, wherein the separating means further comprises:
at least one ejection device to eject the objects from the stream towards at least one device to receive the ejected objects; and
at least one guide device comprising a plurality of deflectors to distribute the ejected objects in relation to the sorting instruction, towards their respective containers, the piloting means comprise, in one or more elements:
a calculator able to define an order of ejection or non-ejection in relation to the results of the analysis made by the analysis means and to a sorting instruction; and
a central control module able to define and/or modify the sorting instruction for the calculator and to configure the guide device in relation to this same sorting instruction.

5. The sorting installation according to claim 3, wherein:
the packing and conveying means comprise a spreader device able to arrange the objects entering the sorting device in a substantially single-layer stream, and a feed conveyor to convey said objects towards the analysis means; and
the recycling means include a recirculation loop sending the non-ejected objects in the sorting device back upstream of the spreader device.

6. The sorting installation according to claim 5, further comprising:
a buffer storage device arranged upstream of the spreader device to uncouple the analysis means and the ejector device from the remainder of the sorting installation.

7. The sorting installation according to claim 6, further comprising:
a flow-rate adjustment device to adjust the flow-rate of objects leaving the storage device so as to maintain a constant feed flow-rate of objects to the analysis means and to the ejection means.

8. The sorting installation according to claim 3, further comprising:
a flow-rate measurement probe, positioned upstream of the analysis means at the packing and transport means to determine the feed flow-rate of objects.

9. The sorting installation according to claim 8, wherein the flow-rate measurement probe is an ultrasound probe measuring the height of the stream of objects at the packing and transport means.

10. The sorting installation according to claim 9, wherein the flow-rate measurement probe is an optical sensor measuring the occupancy rate of objects at the packing and transport means.

11. The sorting installation according to claim 4, wherein the device to receive the ejected objects comprises a conveying device to convey the ejected objects from the ejection device towards the guide device guiding the ejected objects.

12. The sorting installation according to claim 11, wherein the conveying device conveying ejected objects is configured so as to ensure substantially horizontal transport of the ejected objects towards the guide device, and the deflectors of the guide device are configured to push the ejected objects to cause them to leave the conveying device above their assigned container.

13. The sorting installation according to claim 12, wherein the conveying device is a conveyor belt and the deflectors are air jet deflectors.

14. The sorting installation according to claim 12, wherein the conveying device is a conveyor belt and the deflectors are belt deflectors.

15. The sorting installation according to claim 12, wherein the conveying device is a conveyor belt and the deflectors are drum deflectors.

16. The sorting installation according to claim 4, wherein the conveying device is configured so as to ensure substantially vertical transport of the objects ejected towards the guide device, and the deflectors of the guide device are configured so as to guide the ejected objects downwardly over the their assigned container.

17. The sorting installation according to claim 16, wherein the conveying device is a hopper, and the deflectors include a set of flaps arranged in the hopper able to pivot about a horizontal axis so as to delimit a conveying duct for the objects towards the their assigned container.

18. The sorting installation according to claim 4, wherein the separating means comprise two ejection devices and two guide devices which each cooperate with one of the ejection devices.

19. The sorting installation according to claim 4, wherein the analysis means, the calculator and the ejection device form an automatic sorting devices.

20. The sorting installation for objects according to claim 19, wherein said sorting installation comprises two identical sorting stations arranged in series upstream of the device to receive the ejected objects and piloted by the piloting means, the first sorting station being intended for the sorting of objects and the second sorting station being intended to control the quality of sorting performed by the first sorting station.

21. The sorting installations according to claim 3, wherein the analysis means comprises a device to determine the constituents of the objects by analyzing the emission spectrum of the objects in the near infrared range.

22. The sorting installation according to claim 20, wherein at least one of the sorting stations comprises additional analysis means coupled to the first analysis means.

23. The sorting installation according to claim 21 further comprising at least one sorting station including additional analysis means.
